(19) United States
(12) Patent Application Publication
(10) Pub. No.: US 2012/0182187 A1
(43) Pub. Date: Jul. 19, 2012

(54) THIN ANTENNA AND AN ELECTRONIC DEVICE HAVING THE THIN ANTENNA

(76) Inventor: Kuan-Hsueh TSENG, Taipei Hsien (TW)

(21) Appl. No.: 13/432,463

(22) Filed: Mar. 28, 2012

Related U.S. Application Data
(62) Division of application No. 12/385,111, filed on Mar. 31, 2009.

(30) Foreign Application Priority Data
Jun. 26, 2008 (TW) 097123919

(51) Int. Cl. H01Q 1/38

(52) U.S. Cl. 343/700 MS

(57) ABSTRACT

A thin antenna for wireless signal transmission of an electronic device is disclosed. The thin antenna comprises a base board, a first radiation area, a first ground area and a feeding plane. The base board has a first plane and a second plane. The first radiation area is printed on the second plane. The first ground area is printed on the first plane. The feeding plane is printed on the first plane. The feeding plane has a feeding point. Wherein the area of the feeding plane is smaller than the area of the first radiation area, and the area of the feeding plane is partly covered by the region which is projected from the first radiation area corresponding to the first plane.

### BACKGROUND OF THE INVENTION

1. Field of the Invention

The present invention relates to a thin antenna and an electronic device which contains a thin antenna, more specifically, to a thin antenna that employs a coupling feed and an electronic device having the thin antenna.

2. Description of the Related Art

Electronic products in the market have become lighter and smaller with the advancement of technology. In particular, laptop users require not only the functionalities of the laptop computers; but they also require the laptops to be lightweight and slim. Therefore, a traditional antenna can not be disposed in the structure of the laptop computers.

A thin antenna designed for a laptop computer is disclosed in the prior art. Please refer to FIG. 1A for the thin antenna as disclosed by the prior art. The antenna 90 in the prior art belongs to a type of monopole antenna which employs direct feed. The antenna 90 in the prior art comprises a base board 91, a radiation element 92, a ground element 93 and a feeding point F; the radiation element 92 and the ground element 93 are printed on the base board 91, and signals are fed into the feeding point F directly to transmit an electronic signal.

Next, refer to FIG. 1B which shows the Voltage Standing Wave Ratio (VSWR) at different frequencies for antenna 90 shown in FIG. 1A. It can be seen from FIG. 1B that the antenna 90 can only transmit in the frequency band ranging around 2.5 GHz and 5 GHz, however, the matching ability is poor at the low frequency end (2.5 GHz). Thus there are many operating frequency bandwidth restrictions for the antenna 90 in the prior art.

Therefore, it is desirable to provide a thin antenna to mitigate and/or obviate the aforementioned problems.

### SUMMARY OF THE INVENTION

A main object of the present invention is to provide a thin antenna which can achieve the effect of coupling feed.

Another object of the present invention is to provide an electronic device which comprises the thin antenna.

To achieve the above mentioned objectives, the electronic device of the present invention comprises a wireless transmission module and a thin antenna. The thin antenna is electrically coupled with the wireless transmission module. The thin antenna comprises a base board, a first radiation area, a first ground area and a feeding plane. The base board has a first plane and a second plane. The first radiation area is printed on the second plane. The first ground area is printed on the first plane. The feeding plane is printed on the first plane. The feeding plane has a feeding point. The area of the feeding plane is smaller than the area of the first radiation area, and the feeding plane is partly covered by the region which is projected from the first radiation area corresponding to the first plane.

### BRIEF DESCRIPTION OF THE DRAWINGS

FIG. 1A shows a thin antenna disclosed by the prior art.

FIG. 1B shows the VSWR under different frequencies according to the antenna shown in FIG. 1A.

FIG. 2A shows the front view according to the first embodiment of the invention.

FIG. 2B shows the rear view according to the first embodiment of the invention.

FIG. 2C shows the perspective view according to the first embodiment of the invention.

FIG. 2D shows the VSWR at different frequencies according to the first embodiment of the invention.

FIG. 3A shows the front view according to the second embodiment of the invention.

FIG. 3B shows the rear view of the second embodiment of the invention.

FIG. 3C shows the perspective view according to the second embodiment of the invention.

FIG. 3D shows the VSWR at different frequencies according to the second embodiment of the invention.

FIG. 4A shows the front view according to the third embodiment of the invention.

FIG. 4B shows the rear view according to the third embodiment of the invention.

FIG. 4C shows the perspective view according to the third embodiment of the invention.

FIG. 4D shows the VSWR at different frequencies according to the third embodiment of the invention.

FIG. 5A shows the front view according to the fourth embodiment of the invention.

FIG. 5B shows the rear view according to the fourth embodiment of the invention.

FIG. 5C shows the perspective view according to the fourth embodiment of the invention.

FIG. 5D shows the VSWR at different frequencies according to the fourth embodiment of the invention.

FIG. 6A is a block diagram showing the front view according to the fifth embodiment of the invention.

FIG. 6B is a block diagram showing the rear view according to the fifth embodiment of the invention.

FIG. 6C is a block diagram showing the perspective view according to the fifth embodiment of the invention.

FIG. 6D shows the VSWR at different frequencies according to the fifth embodiment of the invention.

FIG. 7A is a block diagram showing the front view according to the sixth embodiment of the invention.

FIG. 7B is a block diagram showing the rear view according to the sixth embodiment of the invention.

FIG. 7C is a block diagram showing the perspective view according to the sixth embodiment of the invention.

FIG. 7D shows the VSWR at different frequencies according to the sixth embodiment of the invention.

FIG. 8A shows the front view according to the seventh embodiment of the invention.

FIG. 8B shows the rear view according to the seventh embodiment of the invention.

FIG. 8C shows the perspective view according to the seventh embodiment of the invention.

FIG. 8D shows the VSWR at different frequencies according to the seventh embodiment of the invention.

FIG. 9 is a system diagram of an electronic device of the invention.

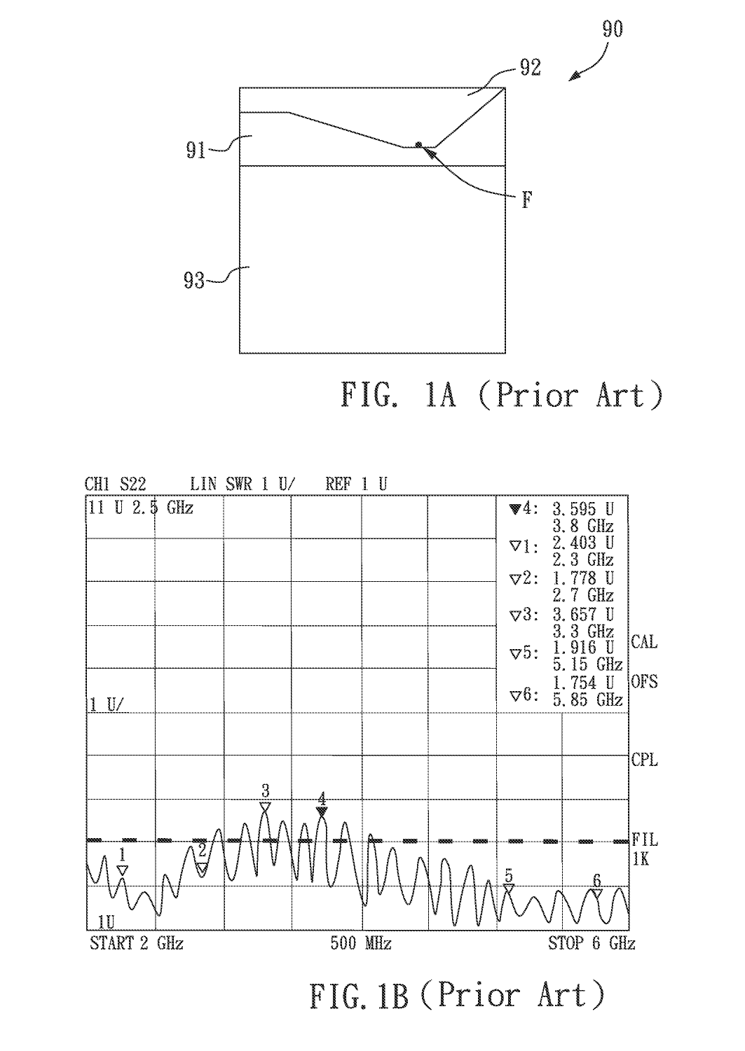

### DETAILED DESCRIPTION OF THE PREFERRED EMBODIMENT

The advantages and innovative features of the invention will become more apparent from the following preferred embodiments.

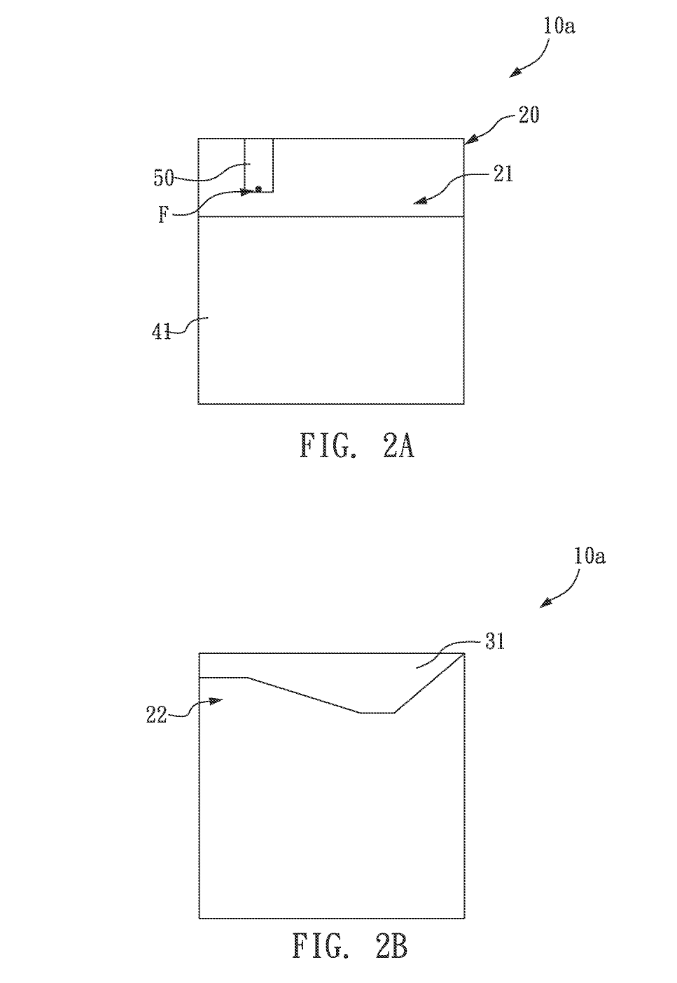

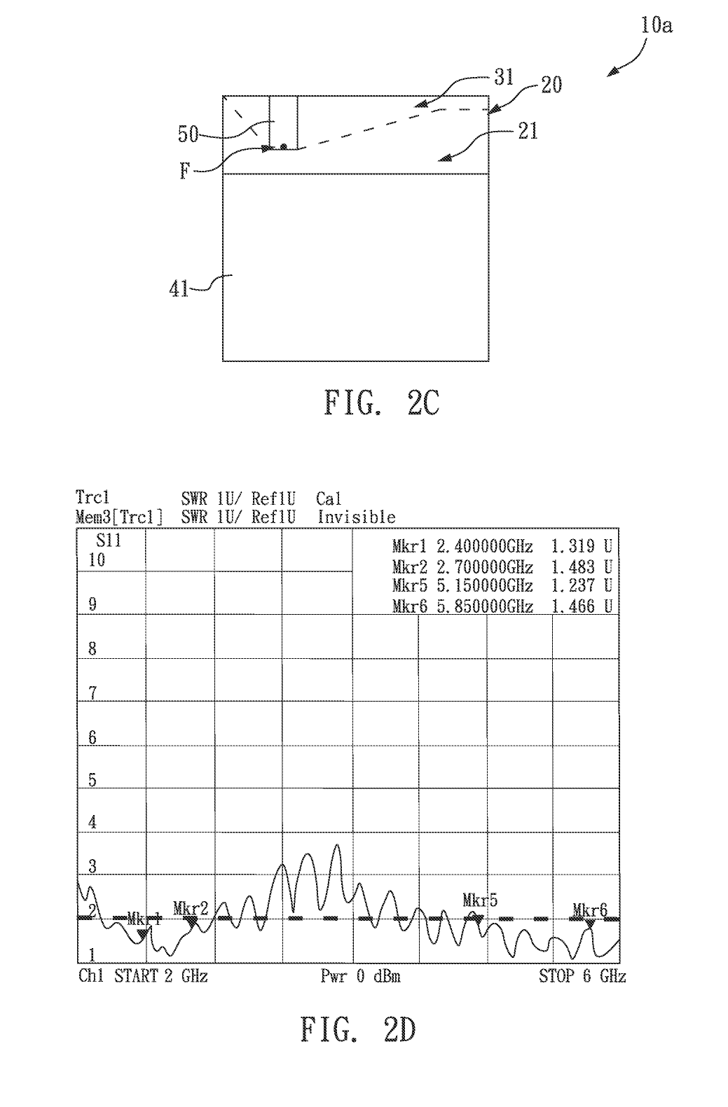

Refer to FIG. 2A to FIG. 2C which show the first embodiment of a thin antenna for the invention. FIG. 2A is the front view according to the first embodiment, FIG. 2B is the rear view according to the first embodiment and FIG. 2C is the perspective view according to the first embodiment.

As shown in FIG. 2A to FIG. 2C, a thin antenna 10a is a type of antenna which employs coupling feed. The thin antenna 10a comprises a base board 20. The base board 20 comprises a first plane 21 and a second plane 22. A first ground area 41 and a feeding plane 50 are printed on the first plane 21. A first radiation area 31 is printed on the second plane 22.

The base board 20 is an FR4 grade (Flame Retardant 4) base board, for example a printed circuit board, however the invention is not limited to this material. The base board 20 can also be a plastic board or a glass fiber board. The length of the first radiation area 31 is the same as the base board 20, but the length of the first radiation area 31 can also be shorter than the length of the base board 20 (as shown in 4B). The first radiation area 31 is used for transmitting wireless communication signals. The first ground area 41 is used for grounding the thin antenna 10a.

The area of the feeding plane 50 is smaller than the first radiation area 31. The area of the feeding plane 50 falls within the region which is projected from the first radiation area 31 corresponding to the first plane 21. Similarly, the area of the feeding plane 50 described in the other embodiments also falls within the region which is projected from the radiation area 31 corresponding to the first plane 21. As shown by the perspective view in FIG. 2C, the area of the feeding plane 50 is entirely covered by the region which is projected from the radiation area 31 corresponding to the first plane 21. However, the invention is not limited to this configuration. When considering the effect of coupling feed, the area of the feeding plane 50 only needs to be partly covered by the region which is projected from the radiation area 31 corresponding to the first plane 21.

A feeding point F is located on the edge of the feeding plane 50. The feeding point F is electrically coupled with a feeding line (not shown) to transmit an electronic signal. As an example, the feeding line can be a RF Cable; however, the invention is not limited to the RF Cable. When the electronic signal is fed into the feeding plane 50, the first radiation area 31 is activated through coupling and then wireless signals are emitted through radiation. The feeding point 50 can be used to adjust the impedance matching of the thin antenna 10a, it can also be used as a radiation region to emit wireless signals, and its resonance effect will results in another operating frequency bandwidth.

FIG. 2D shows the VSWR of different frequencies for the thin antenna 10a. As shown in FIG. 2D, the VSWR falls below 2 for frequency band ranging from 2.2 GHz to 2.8 GHz and for frequency band ranging from 4.8 GHz to 6 GHz. The Wireless fidelity (Wi-Fi) frequency band ranges from 2.4 GHz to 2.5 GHz and ranges from 5.18 GHz to 5.85 GHz. Therefore, the thin antenna 10a complies with the Wi-Fi frequency band requirements. The thin antenna 10a has a broader frequency bandwidth and has a better transmission effect at lower frequency band as compared to the antenna 90 in the prior art.

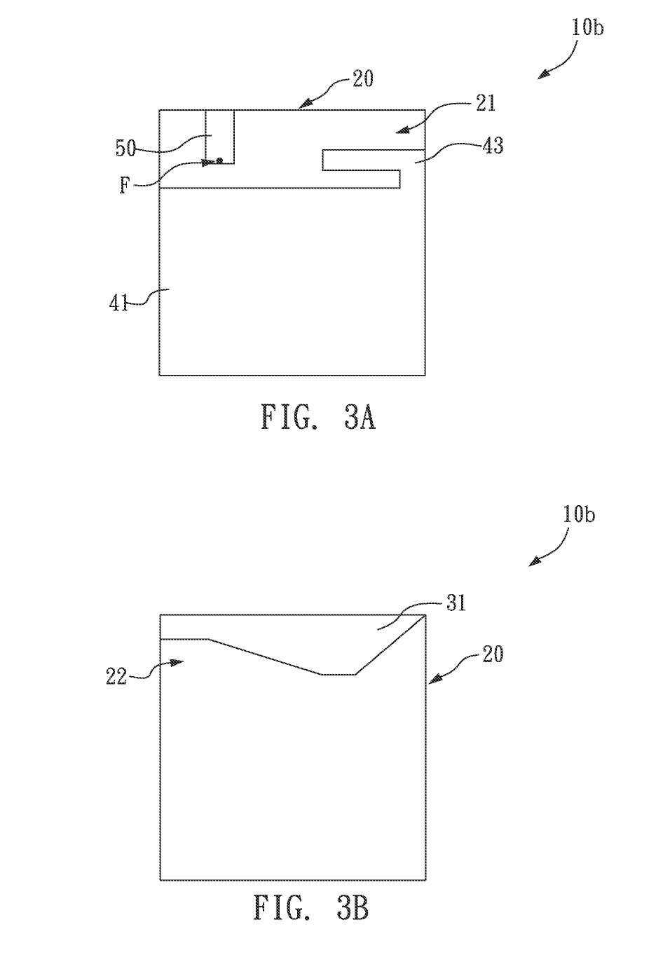

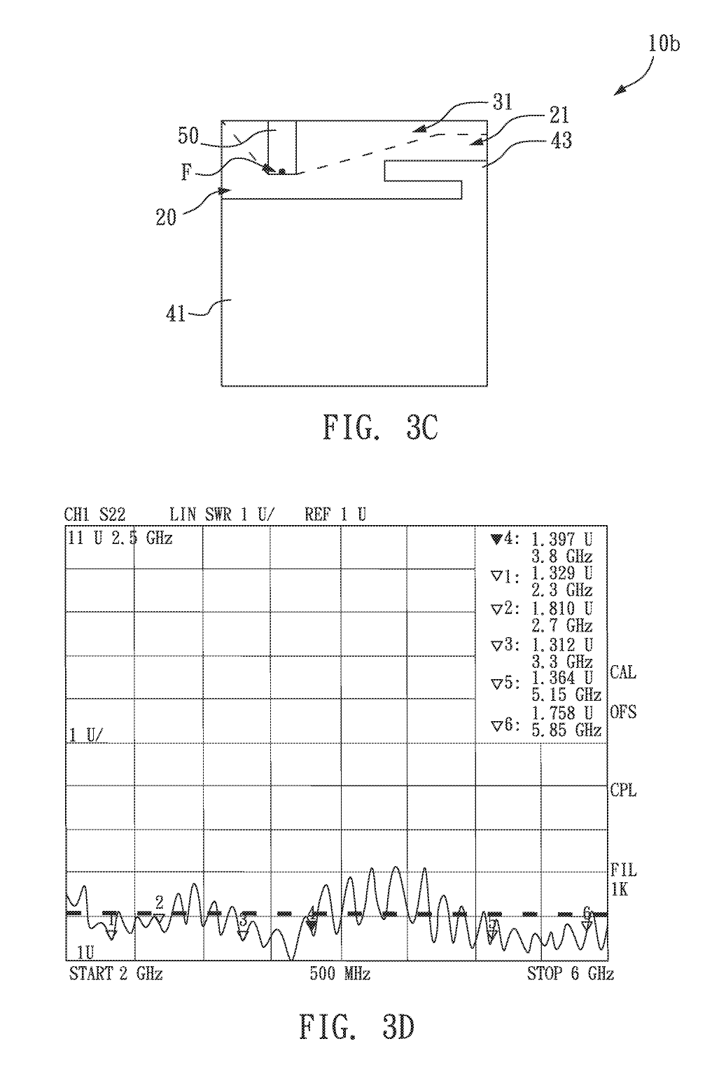

Next, please refer to FIG. 3A to FIG. 3C which show the second embodiment of a thin antenna for the invention. FIG. 3A is the front view of the second embodiment, FIG. 3B is the rear view of the second embodiment and FIG. 3C is the perspective view of the second embodiment.

The second embodiment is different from the first embodiment in that a parasitic element 43 is extended from the first ground area 41 of the thin antenna 10b, which is a structure used for creating a lower operating frequency band through its resonance. By employing the parasitic element 43 and making use of its resonance effect, another low operating frequency band can be obtained by the thin antenna 10b.

FIG. 3D shows the VSWR of different frequencies for the thin antenna 10b. As shown in FIG. 3D, the thin antenna 10b is operable for frequency band ranging from 3.3 GHz to 3.8 GHz. The Worldwide Interoperability for Microwave Access (WiMAX) frequency band requirement ranges from 2.3 GHz to 2.7 GHz and from 3.3 GHz to 3.8 GHz. Therefore, the thin antenna 10b complies with the WiMAX frequency band requirements.

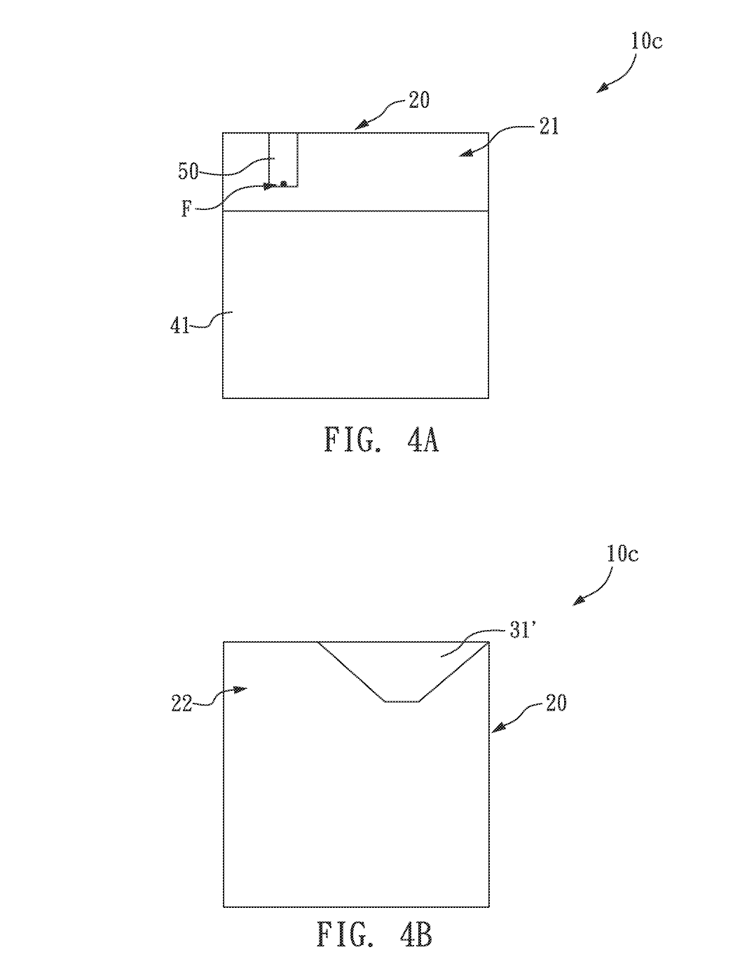

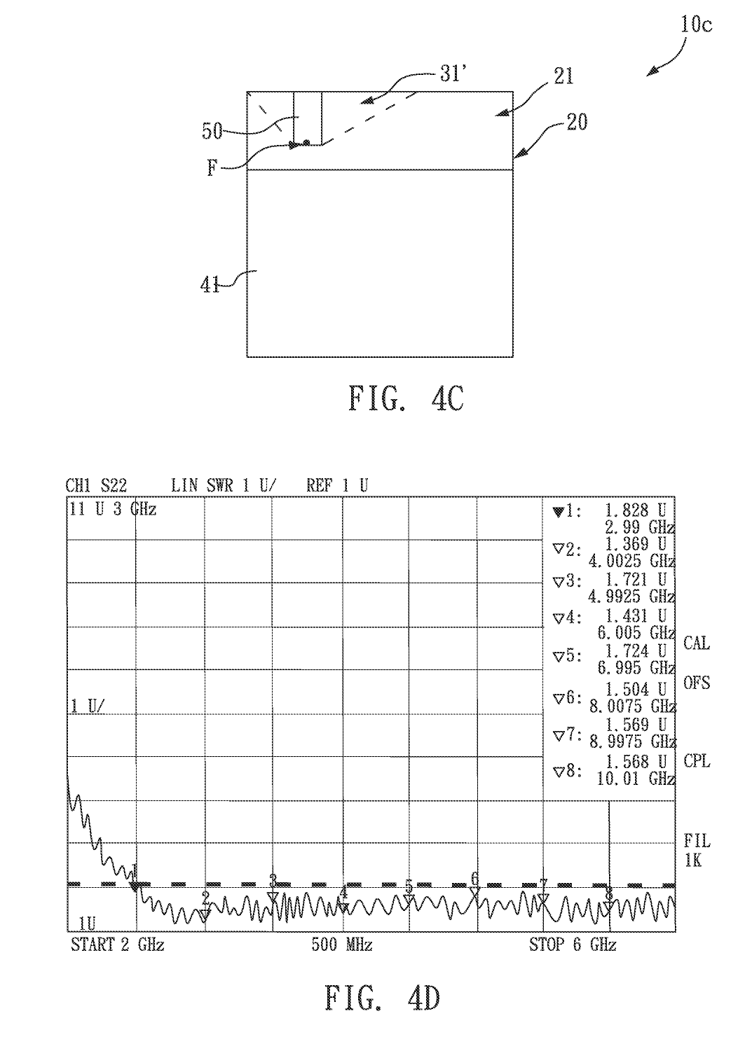

Next, refer to FIG. 4A to FIG. 4C which show the third embodiment of a thin antenna for the invention. FIG. 4A is the front view of the third embodiment, FIG. 4B is the rear view of the third embodiment and FIG. 4C is the perspective view of the third embodiment.

The third embodiment is different from the first embodiment in that the length of the first radiation area 31′ of thin antenna 10c is shorter than the base board 20. Thus the first radiation area 31′ has a smaller surface area as compared to the first radiation area 31 in the thin antenna 10a illustrated in the first embodiment. As a result, the thin antenna 10c will have a higher operating frequency band.

FIG. 4D shows the VSWR of different frequencies for the thin antenna 10c. As shown in FIG. 4D, the thin antenna 10c is operable for frequency band ranging from 3 GHz to 11 GHz. The operable antenna frequency requirement of the Ultra-wideband (UWB) ranges from 3 GHz to 11 GHz. Therefore the thin antenna 10c complies with the UWB frequency requirements.

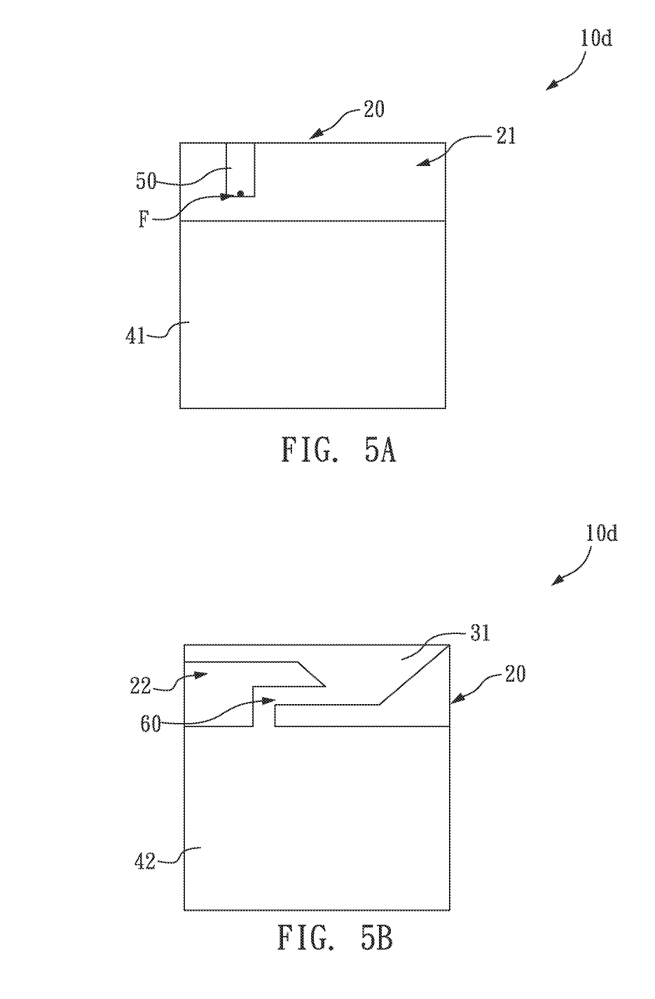

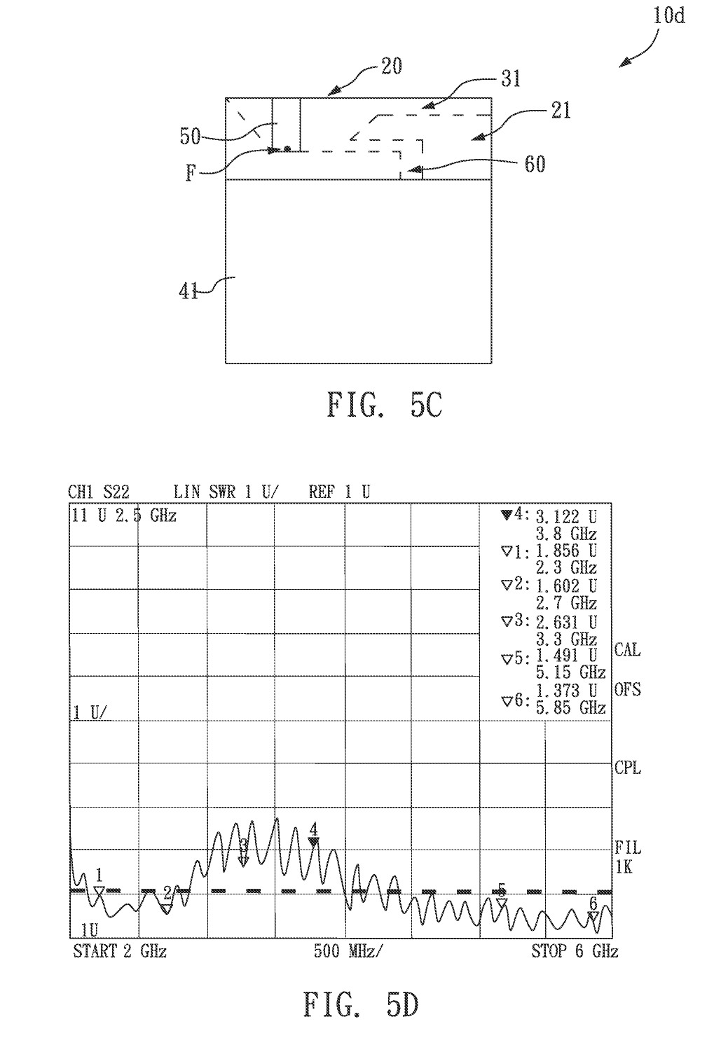

The ground area of the invention can be printed onto surfaces other than the first plane 21. Please refer to FIG. 5A to FIG. 5C which show the fourth embodiment of a thin antenna for the invention. FIG. 5A is the front view of the fourth embodiment, FIG. 5B is the rear view of the fourth embodiment and FIG. 5C is the perspective view of the fourth embodiment.

As shown in FIG. 5A to FIG. 5C for the fourth embodiment, a second ground area 42 is printed on a second plane 22 of a thin antenna 10d. The second ground area 42 is conducted with the first ground area 41. Therefore the ground area of the antenna 10d is increased through the combination of a first ground area 41 and a second ground area 42. Furthermore, the thin antenna 10d comprises a short circuit element 60, which connects the first radiating area 31 with the second ground area 42 to improve the resonance effect of the thin antenna 10d.

FIG. 5D shows the VSWR of different frequencies for thin antenna 10d. As shown in FIG. 5D, the thin antenna 10d complies with the Wi-Fi frequency band requirements. The thin antenna 10d in the fourth embodiment has a broader operating frequency band as compared to the thin antenna 10a illustrated in the first embodiment.

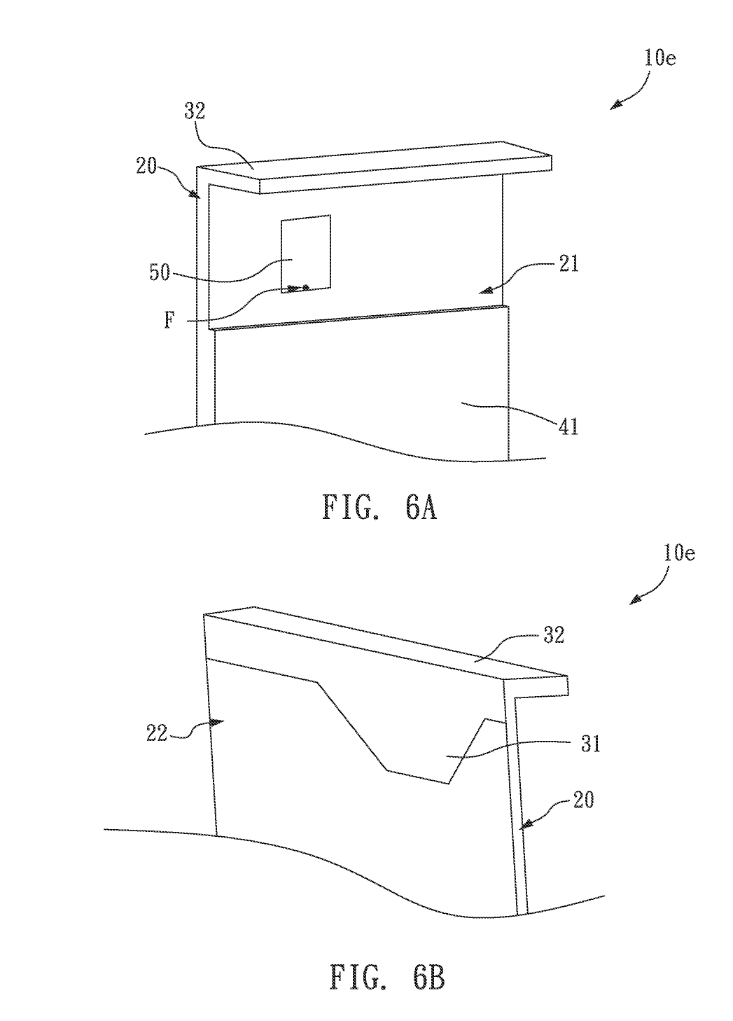

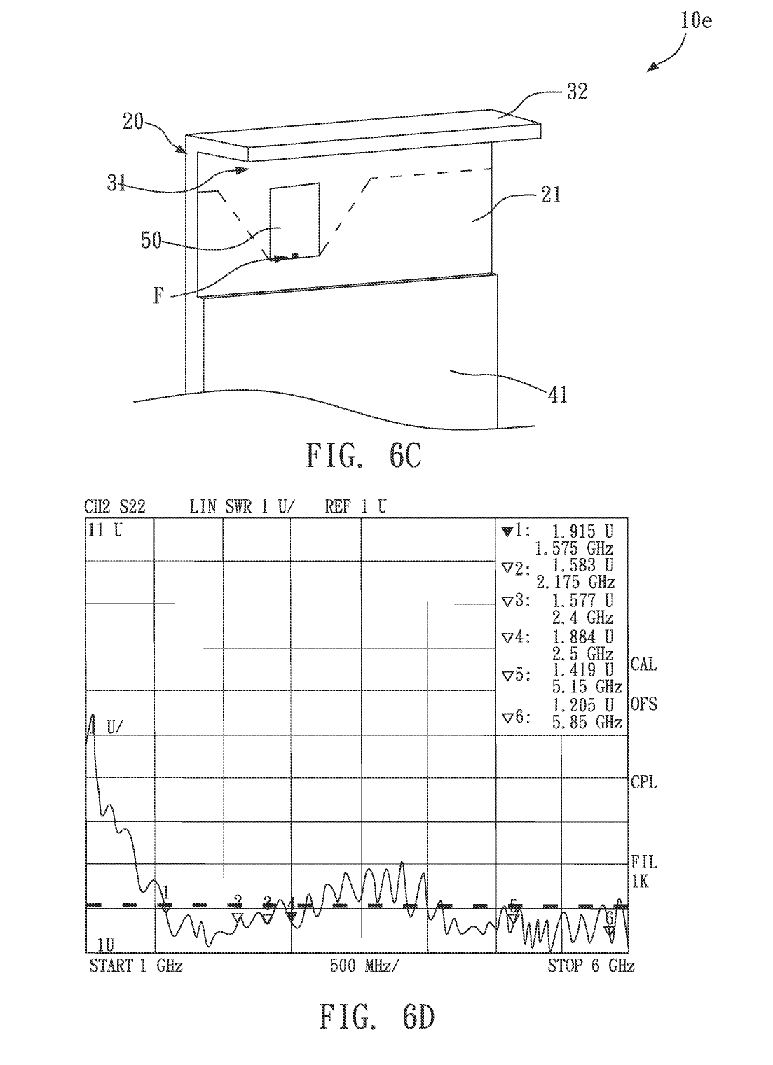

Next, refer to FIG. 6A to FIG. 6C which show the fifth embodiment of a thin antenna for the invention. FIG. 6A is a block diagram showing the front view of the fifth embodiment, FIG. 6B is a block diagram showing the rear view of the fifth embodiment and FIG. 6C is a block diagram showing the perspective view of the fifth embodiment.

In the fifth embodiment, a second radiation area 32 is extended from a first radiation area 31 of a thin antenna 10e. The second radiation area 32 is a metal sheet, facing towards the first plane 21, and is substantially connected with the first radiation area 31 in a perpendicular manner. Therefore, when the electric signal is fed into the feeding point F, the transmission path of electric flow is now extended for the antenna 10e. Take note that the facing direction of the second radiation area 32 illustrated in FIG. 6A to FIG. 6C are just a concept, the invention is not limited to the direction illustrated in FIG. 6A to FIG. 6C. The second radiation area 32 can be utilized by the thin antenna 10e to obtain a lower operable frequency band.

FIG. 6D shows the VSWR of different frequencies for the thin antenna 10e. As shown in FIG. 6D, the thin antenna 10e is operable within frequency band ranging from 1.5 GHz to 2.5 GHz.

The frequency band for GPS is approximately 1575 MHz; the frequency band for DCS is approximately 1710 MHz to 1880 MHz; the frequency band for PCS is approximately 1850 MHz to 1990 MHz and the frequency band for UMTS is approximately 1920 MHz to 2170 MHz.

The thin antenna 10e complies with the antenna frequency band requirements of the Global Positioning System (GPS), the Digital Communication System (DCS), the Personal Communications Service (PCS), the Universal Mobile Telecommunications System (UMTS) and the WiFi.

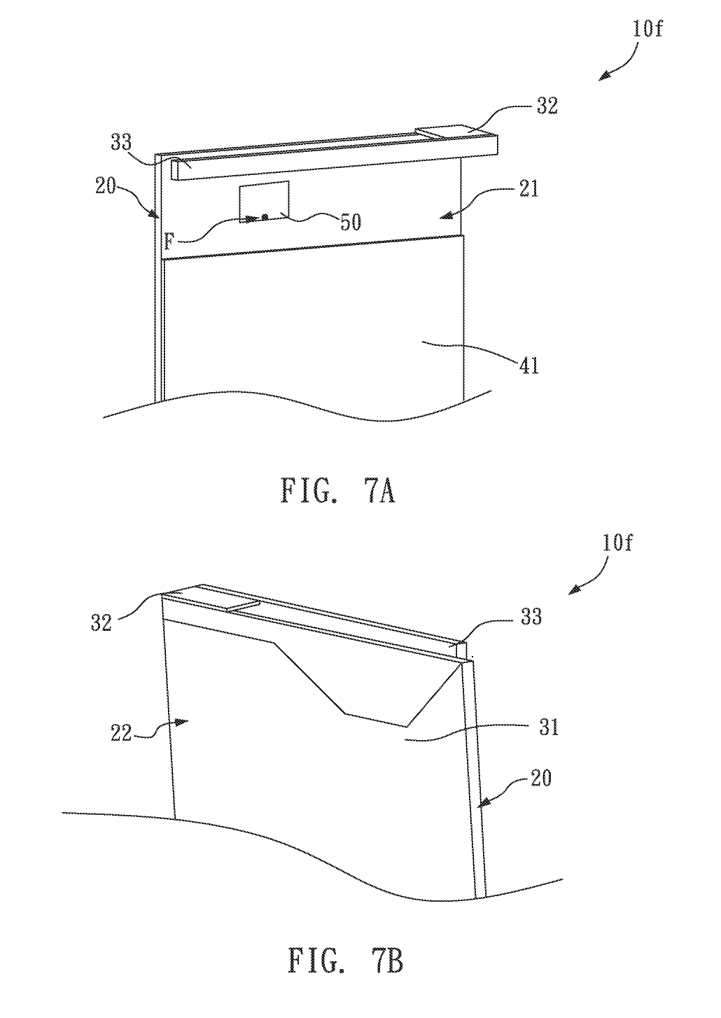

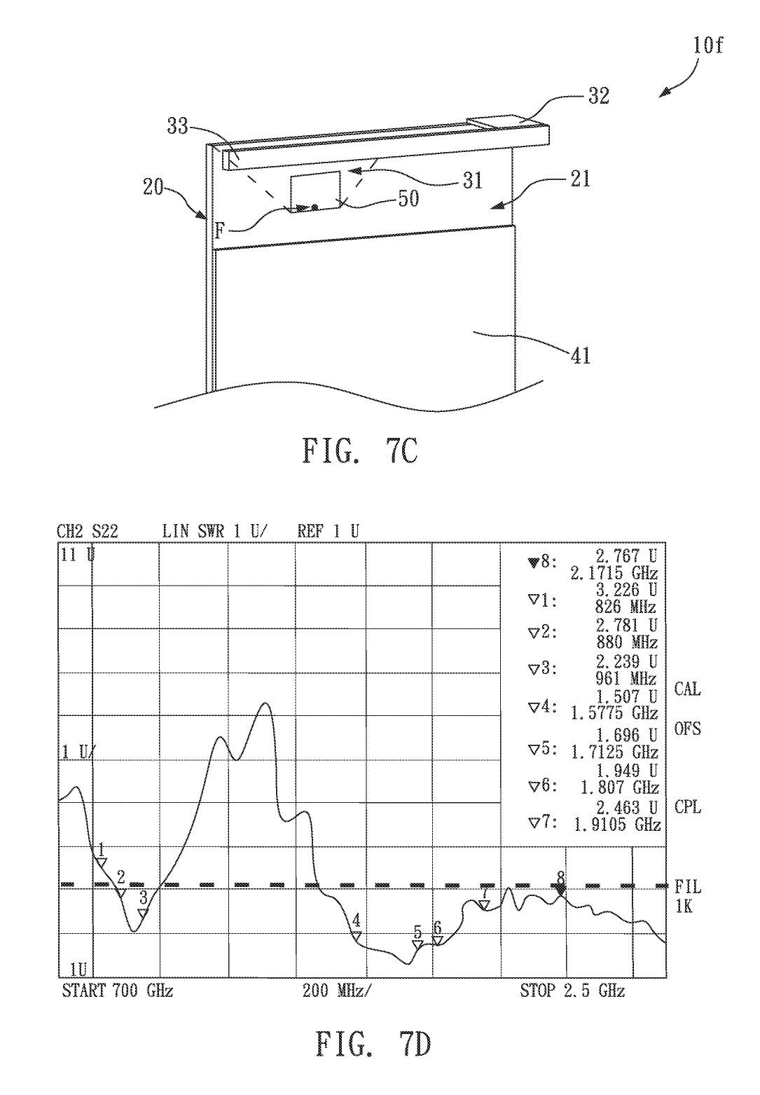

Next, refer to FIG. 7A to FIG. 7C which show the sixth embodiment of a thin antenna for the invention. FIG. 7A is a block diagram showing the front view of the sixth embodiment, FIG. 7B is a block diagram showing the rear view of the sixth embodiment and FIG. 7C is a block diagram showing the perspective view of the sixth embodiment.

In the invention, the sixth embodiment is different from the fifth embodiment in that a third radiation area 33 is an extension from a second radiation area 32 of the an antenna 10f. The third radiation area 33 is a metal sheet, and is substantially connected with second radiation area 32 in a perpendicular manner. As compared to the thin antenna 10e, the antenna 10f comprises the third radiation area 33, thus electric signals can have an extended transmission path of electric flow. Therefore the third radiation area 33 can be utilized by the thin antenna 10f to obtain a lower operable frequency band as compared to the thin antenna 10e.

FIG. 7D shows the VSWR of different frequencies for the thin antenna 10f. As shown in FIG. 7D, the thin antenna 10f not only complies with the antenna frequency band requirements of the GPS, the DCS, the PCS and the UMTS, the thin antenna 10f can also be used in the frequency band of the Advanced Mobile Phone System (AMPS) and the Global System for Mobile Communications (GSM). The frequency band of AMPS ranges from 824 MHz to 894 MHz; the frequency band of GSM ranges from 880 MHz to 960 MHz.

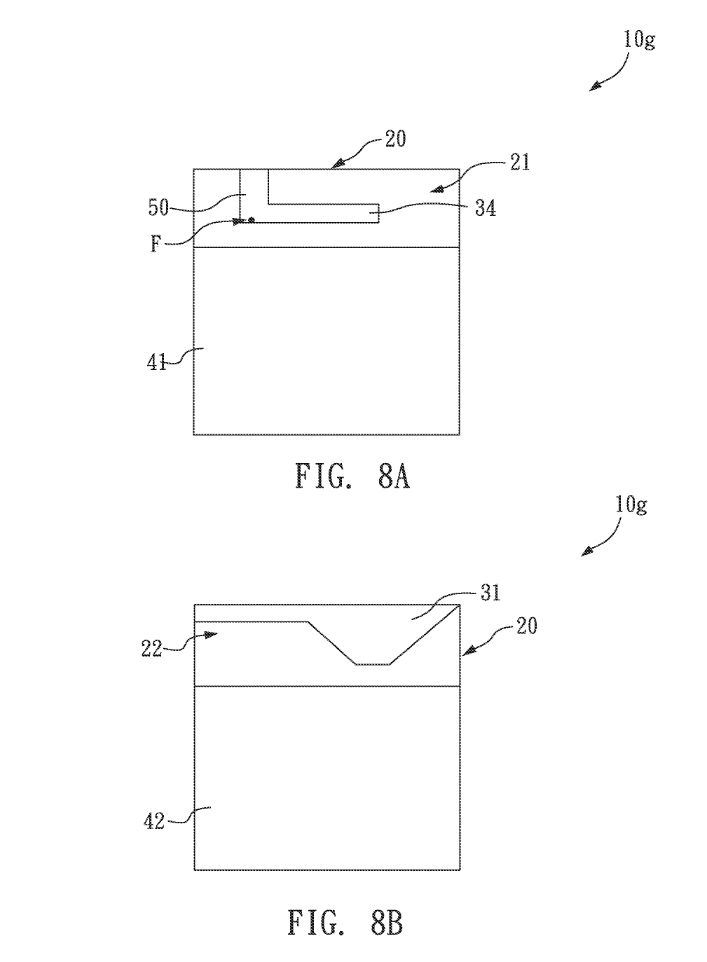

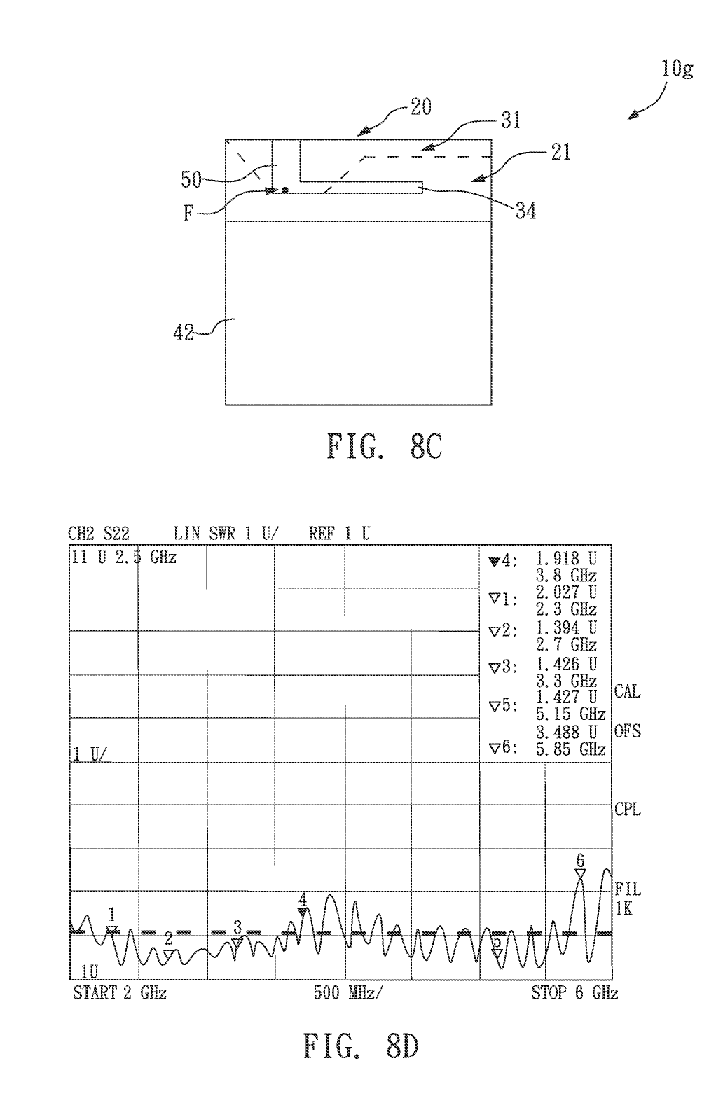

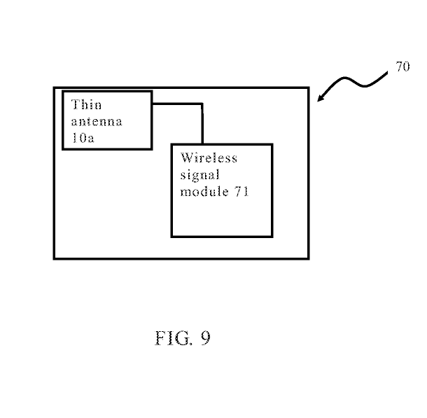

Next, refer to FIG. 8A to FIG. 8C which show the seventh embodiment of a thin antenna for the invention. FIG. 8A shows the front view of the seventh embodiment, FIG. 8B shows the rear view of the seventh embodiment and FIG. 8C shows the perspective view of the seventh embodiment.

In the invention, the seventh embodiment is different from the first embodiment in that a fourth radiation area 34 is extended from a feeding plane 50 of a thin antenna 10g. The fourth radiation area 34 exceeds the region which is projected from the first radiation area 31 corresponding to the first plane 21. As shown in the perspective view in FIG. 8C, the fourth radiation area 34 exceeds the region which is projected from the first radiation area 31 corresponding to the first plane 21. The fourth radiation area 34 can be deployed by the thin antenna 10g as a radiation region, and its resonance effect will result in another operating frequency band.

FIG. 8D shows the VSWR of different frequencies for the thin antenna 10g. As shown in FIG. 8D, the thin antenna 10g is operable for frequency band ranging from 2.3 GHz to 3.8 GHz. Thus the thin antenna 10g has a broader low frequency bandwidth as compared to thin antenna 10a.

Finally, refer to FIG. 9 for a system diagram of an electronic device. In the embodiments of the invention, the electronic device 70 can be a mobile device such as a laptop computer or a GPS, but the invention is not limited to these devices.

As shown in FIG. 9, the electronic device 70 comprises a thin antenna 10a and a wireless signal module 71. In the electronic device 70, RF cables (not shown) can be fed into the thin antenna 10a and then electrically coupled with the wireless transmission module 71. The wireless transmission module 71 is used to process the signals received and transmitted by the thin antenna 10a. Therefore, the thin antenna 10 can be used by the electronic device 70 to receive and transmit signals to achieve wireless communication with other devices (not shown).

Take note that the electronic device 70 can also comprise other antennas. A range of the thin antennas such as 10b to 10g can be chosen to replace the thin antenna 10a to accommodate for different frequency requirements, so that wireless signal can be received or transmitted at different frequency band.

Although the present invention has been explained in relation to its preferred embodiment, it is to be understood that many other possible modifications and variations can be made without departing from the spirit and scope of the invention as hereinafter claimed.

What is claimed is:

1. A thin antenna comprising:
a base board having a first plane and a second plane;
a first radiation area which is printed on the second plane;
a first ground area which is printed on the first plane;
a second ground area which is printed on the surface of the second plane and conducted with the first ground area; and
a feeding plane which is printed on the first plane having a feeding point, wherein the area of the feeding plane is smaller than the area of the first radiation area, and the area of the feeding plane is partly covered by the region which is projected from the first radiation area corresponding to the first plane.

2. The thin antenna as claimed in claim 1, the thin antenna further comprising a short circuit element, wherein the short circuit element is printed on the second plane to connect with the first radiation area and the second ground area.

3. The thin antenna as claimed in claim 1, wherein the first radiation area further comprises a second radiation area, wherein the second radiation area is substantially connected with the first radiation area in a perpendicular manner.

4. The thin antenna as claimed in claim 3, wherein the second radiation area further comprises a third radiation area, wherein the third radiation area is substantially connected with the second radiation area in a perpendicular manner.

5. An electronic device having a thin antenna and capable of wireless transmissions comprising:
a wireless transmission module; and
a thin antenna electrically connected to the wireless transmission module, the thin antenna comprising:
a base board having a first plane and a second plane;
a first radiation area which is printed on the second plane;
a first ground area which is printed on the first plane;
a second ground area which is printed on the surface of the second plane and conducted with the first ground area; and
a feeding plane which is printed on the first plane having a feeding point, wherein the area of the feeding plane is smaller than the area of the first radiation area, and the area of the feeding plane is partly covered by the region which is projected from the first radiation area corresponding to the first plane.

6. The electronic device having the thin antenna as claimed in claim 5, wherein the thin antenna further comprises a short circuit element, wherein the short circuit element is printed on the second plane and connected with the first radiation area and the second ground area.

7. The electronic device having the thin antenna as claimed in claim 5, wherein the first radiation area further comprises a second radiation area, wherein the second radiation area is substantially connected with the first radiation area in a perpendicular manner.

8. The electronic device having the thin antenna as claimed in claim 7, wherein the second radiation area further comprises a third radiation area, wherein the third radiation area is substantially connected with the second radiation area in a perpendicular manner.
